(19) United States
(12) Patent Application Publication
(10) Pub. No.: US 2019/0323820 A1
(43) Pub. Date: Oct. 24, 2019

(54) AN ARTIFACT FOR IMPROVING VERTICAL RESOLUTION OF RADIATION-BASED IMAGING

(71) Applicant: NANOJET OY, HELSINGIN YLIOPISTO (FI)

(72) Inventors: Ivan KASSAMAKOV, Helsinki (FI); Edward HAEGGSTRÖM, Helsinki (FI); Niklas SANDLER, Helsinki (FI); Anton NOLVI, Järvenpää (FI); Tapani VIITALA, Espoo (FI); Alejandro Garcia PEREZ, Helsinki (FI)

(21) Appl. No.: 16/474,598

(22) PCT Filed: Dec. 12, 2017
(86) PCT No.: PCT/FI2017/050875

§ 371 Date: Jun. 28, 2019

(30) Foreign Application Priority Data
Dec. 28, 2016 (FI) 20166039

(51) Int. Cl. G01B 9/02; G01B 21/04

(52) U.S. Cl. CPC G01B 9/0209; G01B 2210/50; G01B 21/042; G01B 9/02072

(57) ABSTRACT

An artifact for improving the vertical resolution of radiation-based imaging is presented. The artifact has a stepped thickness profile with steps. Adjacent steps are arranged to interact differently with radiation used in the radiation-based imaging. Thus, it is possible to identify which step is, in each imaging situation, vertically closest to the imaging plane related to the radiation-based imaging. Thus, a pre-determined vertical position-value related to the closest one of the steps can be used as a vertical position-value related to a radiation-based imaging result obtained in the imaging situation.

### TECHNICAL FIELD

The disclosure relates to an artifact for improving vertical resolution of radiation-based imaging such as for example microscopy. Furthermore, the disclosure relates to a method for improving the vertical resolution of radiation-based imaging. Furthermore, the disclosure relates to a system for radiation-based imaging.

### BACKGROUND

In microscopy and in other corresponding radiation-based imaging, important metrics include magnification, field-of-view “FOV”, lateral resolution, vertical resolution, sensitivity, and depth of field “DOF” in the vertical direction. The vertical direction is substantially parallel with the main propagation direction of radiation used in the radiation-based imaging, whereas lateral directions are perpendicular to the vertical direction. The lateral resolution depends on the numerical aperture “NA” related to the radiation based imaging so that the size of the finest detail that can be resolved in a lateral direction is proportional to λ/2NA, where λ is the center wavelength of the radiation. NA is n×sin θ, where n is the index of refraction of the medium in which the objective lens is working and θ is the maximal half-angle of the cone of light that can enter or exit the objective lens. The vertical resolution depends on the above-mentioned NA so that the size of the finest detail that can be resolved in the vertical direction is proportional to λ/NA².

In microscopy and in other corresponding radiation based imaging, beams are not directed via a single ideal focus point but a beam distribution becomes hourglass shaped, having a finite waist in a focal plane. The lateral width of the beam distribution as a function of position in the vertical direction is usually called a waist function. The non-ideality of the waist function limits the resolution that is achievable with microscopy and/or other corresponding radiation based imaging. Especially the resolution in the vertical direction is limited due to the non-ideality of the waist function.

### SUMMARY

The following presents a simplified summary to provide a basic understanding of some aspects of different invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying and non-limiting embodiments of the invention.

In accordance with the invention, there is provided a new artifact for improving the vertical resolution of radiation-based imaging. The radiation-based imaging can be microscopy or other corresponding radiation-based imaging. In this document, the term “vertical resolution” is to be understood in a broad sense so that, depending on a case under consideration, the vertical resolution determines the precision with which one can determine the vertical location of a single feature and/or the ability to distinguish two or more vertically nearby features and/or the accuracy of vertical profiling.

An artifact according to the invention has a stepped thickness profile with steps. Adjacent steps are arranged to interact differently with radiation used in the radiation-based imaging so that each step is arranged to interact differently with the radiation than any step adjacent to the first-mentioned step. Thus, it is possible to identify which step is, in each imaging situation, vertically closest to the imaging plane related to the radiation-based imaging. Thus, a pre-determined vertical position-value related to the closest one of the steps can be used as a vertical position-value related to a radiation-based imaging result that is obtained in the imaging situation under consideration.

As it is possible to associate appropriate vertical position-values with radiation-based imaging results obtained with different vertical positions of the imaging plane, it is possible to use for example an ordinary microscope, which is designed for two-dimensional “2D” imaging, for three-dimensional “3D” imaging so that 2D-images are associated with appropriate vertical position-values based on an artifact according to the invention.

An artifact according to an exemplifying and non-limiting embodiment of the invention comprises layers with pre-determined thicknesses. The layers are stacked on top of each other along a vertical direction. The layers are stacked on top of each other in a partially overlapping way so as to form the above-mentioned stepped thickness profile.

One or more of the above-mentioned layers can be for example, but not necessarily, Langmuir-Blodgett films “LBF”. The LBFs can be manufactured in a known way to have a constant thickness of e.g. 2.5 nm. Consequently, the thickness profile of the artifact can be controlled with about 2.5 nm steps by controlling the number of LBFs stacked on each other. The stepped thickness profile can be achieved by arranging different numbers of stacked LBFs on different portions of the artifact. The artifact may further comprise steps created by one or more layers each being made of highly ordered pyrolytic graphite “HOPG” and having the thickness greater than that of a LBF. The thickness of each HOPG layer can be e.g. about 2 μm. The thickness of each HOPG layer can be controlled with steps of about 0.3 μm. With the aid of the one or more HOPG layers, a sufficient thickness of the artifact can be achieved with a smaller number of LBFs. There can be different numbers of HOPG layers in different portions of the artifact so as to achieve the stepped thickness profile. In many cases it is advantageous that each layer that constitutes at least part of an outer surface of the artifact where the radiation depart from the artifact is a LBF because, compared to e.g. HOPG, the optical properties of a LBF are closer to the optical properties of many biological samples.

An artifact of the kind described above can be manufactured e.g. in the following way. First, one takes a substrate of HOPG and peels off, in a known manner, a sufficient number of HOPG layers in order to have a desired thickness. A more controlled thickness can be achieved by using electron-beam lithography to cut away HOPG material. Next, LBF of a lipid film, e.g. stearic acid or phopshatidylcholine, is deposited on top of the HOPG substrate by immersing the HOPG substrate, in a known manner, through a monolayer residing on a sub-phase containing monolayer stabilizing counter ions e.g. Uranyl acetate or CdCl₂. The stepped thickness profile can be achieved by immersing the calibration artifact being manufactured less deep into the sub-phase for the subsequently made LBF layers.

Adjacent steps of the artifact can be arranged to interact differently with imaging radiation for example by using different and/or differently doped LBF film materials for the adjacent steps, by using e.g. electron-beam lithography to create different patterns and/or textures on surfaces of the adjacent steps, and/or in other suitable ways.

Possible materials for preparing the artifact by the Langmuir Blodgett “LB” deposition are fatty acids, fatty alcohols, fatty amines, phospholipids, sterols, and any amphiphilic derivatives of these because these can be used to form even single layers of precise thicknesses between 2-4 nm. The preferential step heights can be produced by repetitive multiple deposition of these fiat single layers by the Langmuir Blodgett technique.

The above-mentioned layers do not necessarily comprise LBFs but films constituting the layers can be produced as well by moulding, spinning, punching, or casting. The films could be produced on glass slides or on any other substrate. In some cases it is advantageous that the substrate is transparent to the radiation. A base layer can be produced first on the substrate and then the layers constituting the stepped thickness profile can be produced on top the base layer.

An artifact according to another exemplifying and non-limiting embodiment of the invention is manufactured so that a sufficiently thick layer is first produced on a substrate and then a form made of e.g. metal and having a stepped shape profile is pressed against the layer in order to shape the layer to have the stepped thickness profile.

It is worth noting that the above-mentioned materials and methods of manufacture are non-limiting examples and artifacts according to different embodiments of the invention can be manufactured in different ways and of different materials which have suitable interacting properties with the radiation used in the imaging and which are suitable for manufacturing an appropriate stepped thickness profile.

In accordance with the invention, there is provided also a new method for improving the vertical resolution of radiation-based imaging of a sample. A method according to the invention comprises:
placing the sample and an artifact according to the invention to be concurrently in the field-of-view “FOV” during the radiation-based imaging,
producing a radiation-based imaging result when one of the steps of the artifact is, in the vertical direction, closer to the imaging plane related to the radiation-based imaging than any other step of the artifact, and
associating, with the radiation-based imaging result, a pre-determined vertical position-value related to the one of the steps.

In accordance with the invention, there is provided also a new system for radiation-based imaging of a sample. A system according to the invention comprises:
an artifact according to the invention, and
an imaging device for producing an imaging result based on first waves arriving from the sample and second waves arriving from the artifact when the sample and the artifact are concurrently in the field-of-view of the imaging device.

The imaging device comprises a translation mechanism for vertically translating the imaging plane related to the radiation-based imaging.

A number of exemplifying and non-limiting embodiments of the invention are described in accompanied dependent claims.

Exemplifying and non-limiting embodiments of the invention both as to constructions and to methods of operation, together with additional objects and advantages thereof, are best understood from the following description of specific exemplifying embodiments when read in connection with the accompanying drawings.

The verbs “to comprise” and “to include” are used in this document as open limitations that neither exclude nor require the existence of un-recited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

Exemplifying and non-limiting embodiments of the invention and their advantages are explained in greater detail below with reference to the accompanying drawings, in which:

FIGS. 1a and 1b illustrate an artifact according to an exemplifying and non-limiting embodiment of the invention,

FIG. 2 illustrates an artifact according to an exemplifying and non-limiting embodiment of the invention,

FIG. 3 illustrates an artifact according to an exemplifying and non-limiting embodiment of the invention,

FIGS. 4a and 4b illustrate an artifact according to an exemplifying and non-limiting embodiment of the invention,

FIGS. 5a and 5b illustrate an artifact according to an exemplifying and non-limiting embodiment of the invention,

FIG. 6 shows a flowchart of a method according to an exemplifying and non-limiting embodiment of the invention for improving the vertical resolution of radiation-based imaging,

FIG. 7 illustrates a system according to an exemplifying and non-limiting embodiment of the invention for radiation-based imaging,

FIG. 8 illustrates a part of a system according to an exemplifying and non-limiting embodiment of the invention for radiation-based imaging,

FIG. 9 illustrates a part of a system according to an exemplifying and non-limiting embodiment of the invention for radiation-based imaging, and

FIGS. 10a-10f illustrate an exemplifying usage of an artifact according to an exemplifying and non-limiting embodiment of the invention.

### DESCRIPTION OF EXEMPLIFYING AND NON-LIMITING EMBODIMENTS

The specific examples provided in the description given below should not be construed as limiting the scope and/or the applicability of the appended claims. Lists and groups of examples provided in the description given below are not exhaustive unless otherwise explicitly stated.

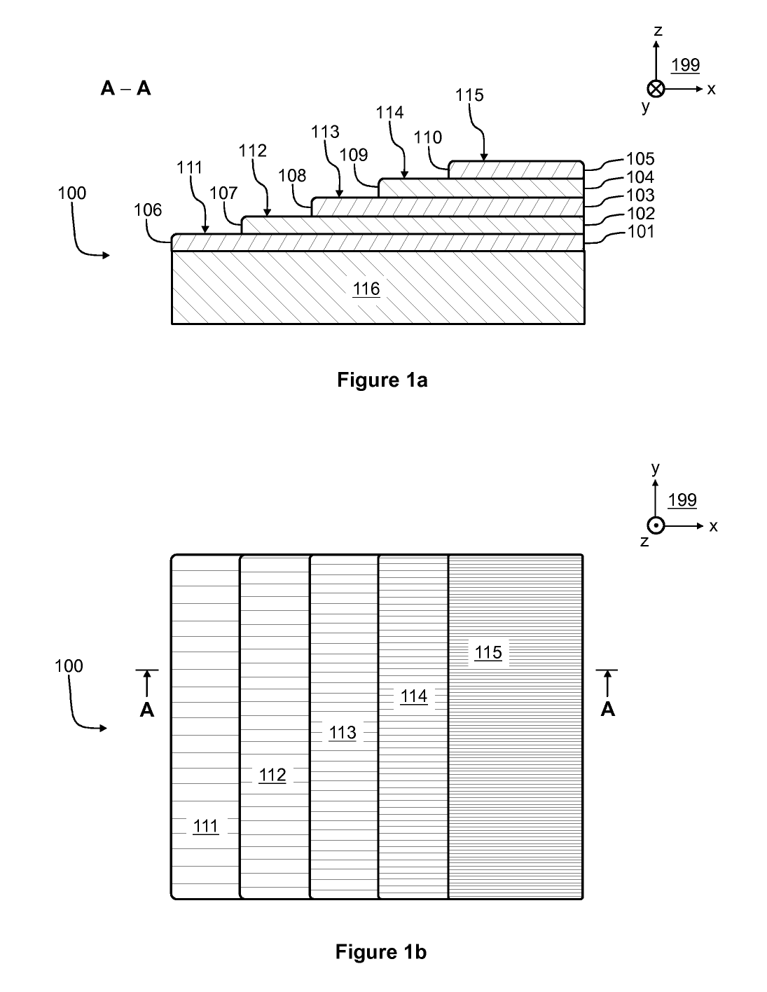

FIGS. 1a and 1b illustrate an artifact 100 according to an exemplifying and non-limiting embodiment of the invention for improving the vertical resolution of radiation-based imaging. The vertical direction of the radiation based imaging is assumed to be parallel with the z-axis of a coordinate system 199. FIG. 1a shows a view of a section taken along a line A-A shown in FIG. 1b, whereas FIG. 1b shows a schematic top view of the artifact 100. In FIG. 1a, the section plane is parallel with the xz-plane of the coordinate system 199. In this exemplifying case, the artifact 100 comprises a substrate 116 and layers 101, 102, 103, 104, and 105 on top of the substrate. The layers 101-105 are stacked on top of each other in a partially overlapping way so as to form a stepped thickness profile having steps 106, 107, 108, 109, and 110. The stepped thickness profile is shown in FIG. 1a. The layers 101-105 may comprise organic material in order to achieve a situation in which appropriate material properties of the artifact 100 are sufficiently close to appropriate material properties of biological or synthetic organic samples to be examined. Organic materials are defined in modern chemistry as carbon-based compounds, originally derived from living organisms but now including lab-synthesized versions as well. The layers 101-105 can be, for example but not necessarily, Langmuir-Blodgett films “LBF” or suitable polymer films. The substrate 102 can be made of e.g. highly ordered pyrolytic graphite “HOPG”, SiO₂, metal, metal oxide, or silicon.

Adjacent steps of the stepped thickness profile of the artifact 100 are arranged to interact differently with the radiation used in the radiation-based imaging. Thus, it is possible to identify which one of the steps 106-110 is, in each imaging situation, vertically closest to the imaging plane related to the radiation-based imaging. Thus, a pre-determined vertical position-value related to the closest one of the steps 106-110 can be used as a vertical position-value related to an imaging result that is obtained in the imaging situation under consideration.

In the exemplifying artifact 100 illustrated in FIGS. 1a and 1b, the substantially horizontal surfaces 111, 112, 113, 114, and 115 of the steps 106-110 are arranged to have different reflective and/or scattering properties concerning the radiation used in the radiation-based imaging. In this document, the “reflective properties” are properties which describe how a surface reflects arriving radiation so that the reflection angle with respect to a vector, normal to the surface, is substantially the same as the incident angle with respect to the above-mentioned vector normal to the surface. In this document, the “scattering properties” are properties which describe how a surface scatters arriving radiation into many directions. The layers 101-105 may comprise for example substances having wavelength-dependent interacting properties with the radiation used in the radiation-based imaging so that the interacting properties of adjacent steps have different wavelength dependencies. In a case where the radiation is polyaromatic visible light, the above-mentioned substances can be color pigments so that adjacent ones of the steps 106-110 have different colors. The color pigments can be mixed into the base materials of the layers 101-105, or the color pigments may constitute the topmost surfaces of the layers 101-105. In FIG. 1b, horizontal hatchings with different spacing depict different wavelength-dependent interacting properties with the radiation, e.g. different colors and/or different interference patterns. In some cases, the wavelength-dependent interacting properties can be dependent also on a viewing angle.

In an artifact according to an exemplifying and non-limiting embodiment of the invention, the layers 101-105 comprise particles interacting with the radiation used in the radiation-based imaging so that adjacent steps have different interacting properties with the radiation. Adjacent steps of the artifact can be made different from each other by using different particles in different ones of the layers 101-105. It is also possible that the amount of the particles per a unit volume is different in different ones of the layers 101-105. Furthermore, it is also possible that the particles are non-evenly distributed in the layers 101-105 so that the particles are arranged to constitute different geometric patterns in different ones of the layers 101-105.

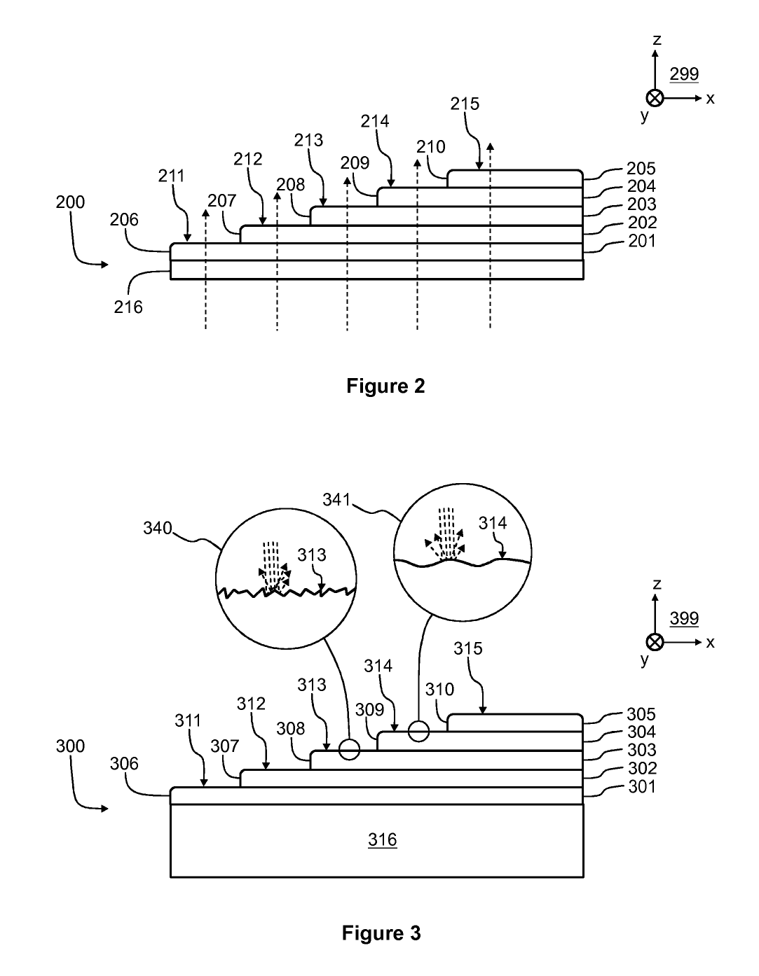

FIG. 2 shows a side view of an artifact 200 according to an exemplifying and non-limiting embodiment of the invention for improving the vertical resolution of radiation-based imaging. The vertical direction of the radiation based imaging is assumed to be parallel with the z-axis of a coordinate system 299. The artifact 200 comprises a substrate 216 and layers 201, 202, 203, 204, and 205 on top of the substrate. The layers 201-205 are stacked on top of each other in a partially overlapping way so as to form a stepped thickness profile having steps 206, 207, 208, 209, and 210. Adjacent ones of the steps 206-210 of the artifact 200 are arranged to interact differently with the radiation used in the radiation-based imaging. In this exemplifying case, the adjacent ones of the steps 206-210 have different radiation-transmission properties for radiation that passes through the artifact 200 along the positive z-direction of the coordinate system 299. In FIG. 2, the radiation that penetrates the artifact 200 in the positive z-direction is depicted with dashed line arrows. The different radiation-transmission properties of the steps 206-210 can be implemented for example by providing the substantially horizontal surfaces 211, 212, 213, 214, and 215 with suitable coatings and/or by arranging roughness and/or other properties of the surfaces 211-215 to differ from each other. It is also possible that the different radiation-transmission properties are implemented by using different materials on different layers of the artifact and/or by using different blend components in the base materials of the different layers and/or by blending different particles into the base materials of the different layers and/or by blending particles in different ways into the base materials of the different layers, e.g. so that the amount of blended particles per a unit volume is different for different layers. Thus, there are many ways to implement the different radiation-transmission properties of the steps 206-210.

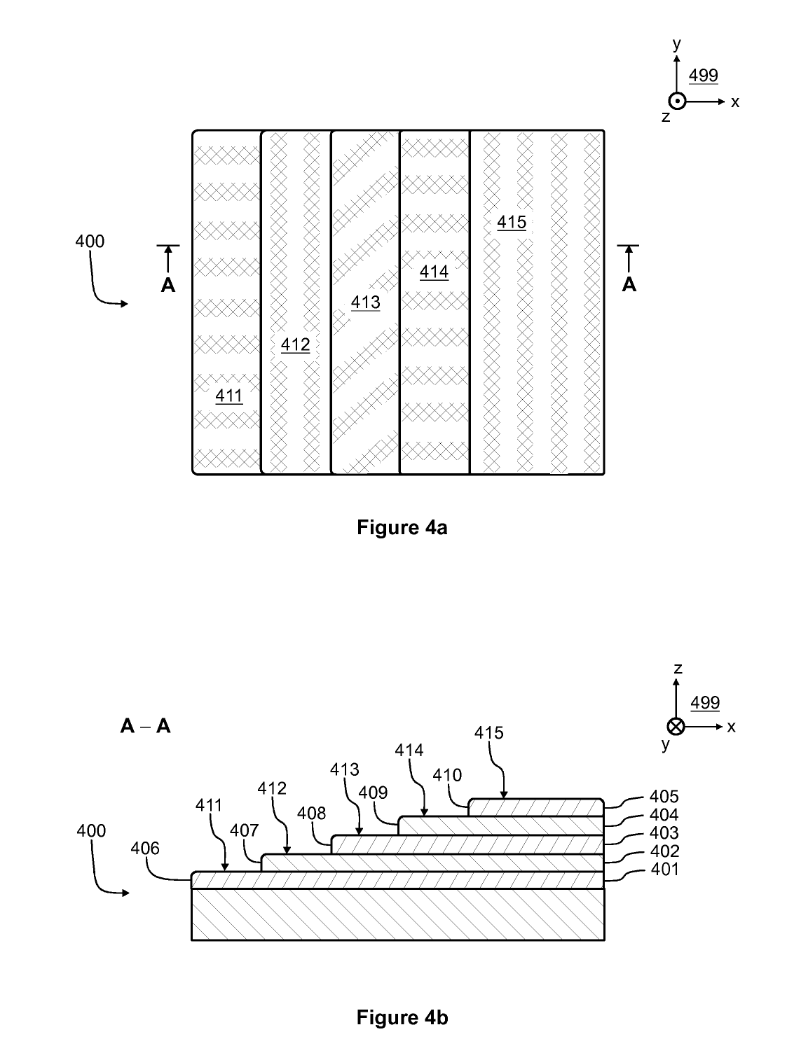

FIG. 3 shows a side view of an artifact 300 according to an exemplifying and non-limiting embodiment of the invention for improving the vertical resolution of radiation-based imaging. The vertical direction of the radiation based imaging is assumed to be parallel with the z-axis of a coordinate system 399. The artifact 300 comprises a substrate 316 and layers 301, 302, 303, 304, and 305 on top of the substrate. The layers 301-305 are stacked on top of each other in a partially overlapping way so as to form a stepped thickness profile having steps 306, 307, 308, 309, and 310. Adjacent steps of the artifact 300 are arranged to interact differently with the radiation used in the radiation-based imaging. In this exemplifying case, surfaces 311, 312, 313, 314, and 315 of the steps 306-310 have textures so that the surfaces of adjacent steps have different textures which have different scattering properties for the radiation used in the radiation-based imaging. The different textures of the surfaces 313 and 314 are illustrated with partial magnifications 340 and 341 shown in FIG. 3.

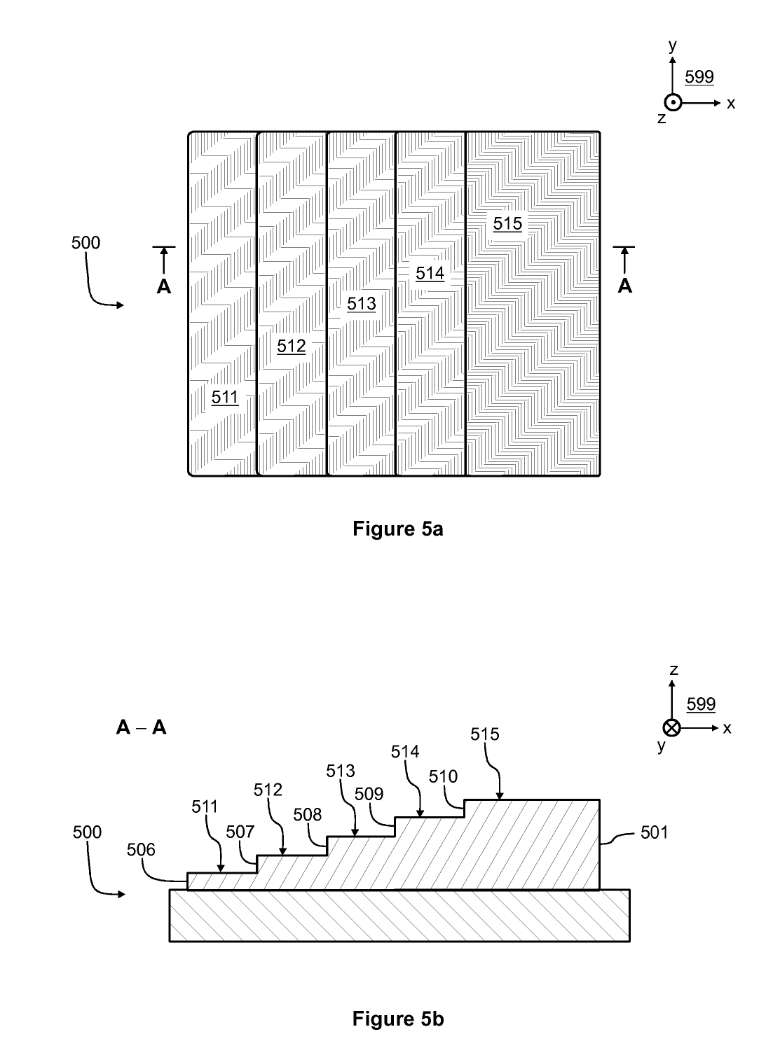

FIGS. 4a and 4b illustrate an artifact 400 according to an exemplifying and non-limiting embodiment of the invention for improving the vertical resolution of radiation-based imaging. The vertical direction of the radiation based imaging is assumed to be parallel with the z-axis of a coordinate system 499. FIG. 4a shows a schematic top view of the artifact 400, whereas FIG. 4b shows a view of a section taken along a line A-A shown in FIG. 4a. In FIG. 4b, the section plane is parallel with the xz-plane of the coordinate system 499. The artifact 400 comprises layers 401, 402, 403, 404, and 405 that are stacked on top of each other in a partially overlapping way so as to form a stepped thickness profile having steps 406, 407, 408, 409, and 410. Adjacent steps of the artifact 400 are arranged to interact differently with the radiation used in the radiation-based imaging. In this exemplifying case, surfaces 411, 412, 413, 414, and 415 of the steps 406-410 have geometric patterns of areas having different interacting properties with the radiation used in the radiation-based imaging so that adjacent steps have different geometric patterns. Areas depicted in FIG. 4a with cross-hatching have first interacting properties with the radiation, and areas depicted in FIG. 4a without cross-hatching have second interacting properties with the radiation, where the second interacting properties differ from the first interacting properties. In a case where the radiation is polychromatic visible light, the areas depicted with the cross-hatching may have a first color and the areas depicted without cross-hatching may have a second color different from the first color. It is also possible that the areas depicted with the cross-hatching may produce a first interference pattern and the areas depicted without cross-hatching may produce a second interference pattern different from the first interference pattern. In some cases, the interacting properties can depend also on viewing angle.

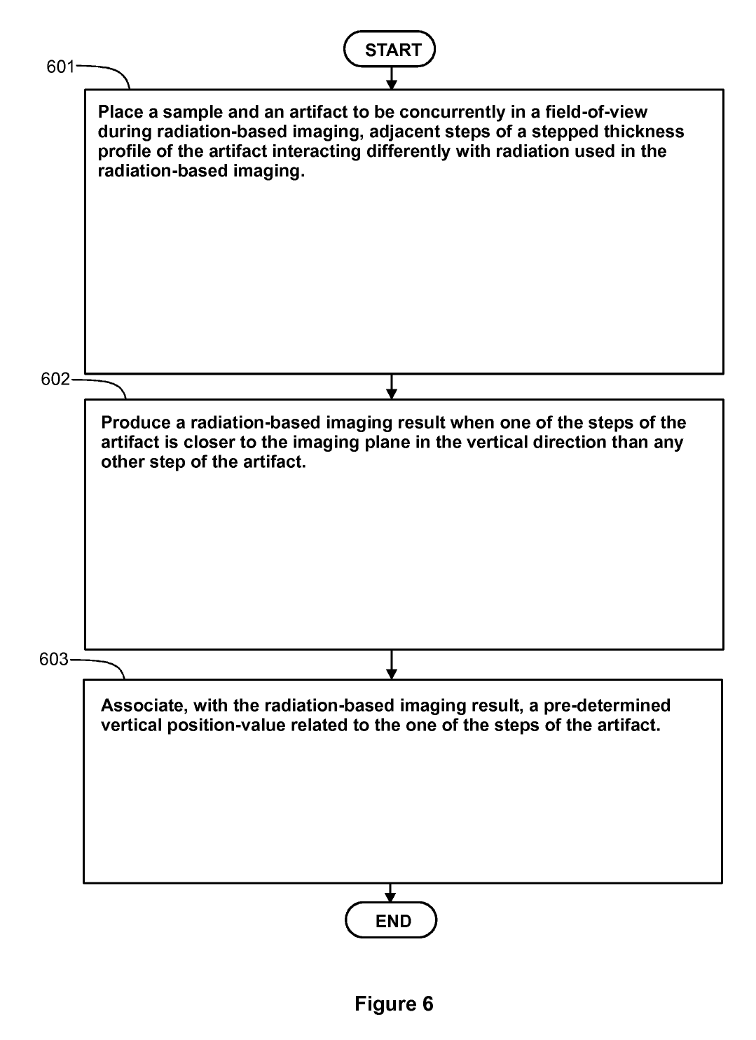

FIGS. 5a and 5b illustrate an artifact 500 according to an exemplifying and non-limiting embodiment of the invention for improving the vertical resolution of radiation-based imaging. The vertical direction of the radiation based imaging is assumed to be parallel with the z-axis of a coordinate system 599. FIG. 5a shows a schematic top view of the artifact 500, and FIG. 5b shows a view of a section taken along a line A-A shown in FIG. 5a. In FIG. 5b, the section plane is parallel with the xz-plane of the coordinate system 599. The artifact 500 comprises a layer 501 that has been shaped to form a stepped thickness profile having steps 506, 507, 508, 509, and 510. Adjacent steps of the artifact 500 are arranged to interact differently with the radiation used in the radiation-based imaging. In this exemplifying case, surfaces 511, 512, 513, 514, and 515 of the steps 506-510 have geometric patterns of areas having different interacting properties with the radiation used in the radiation-based imaging so that the steps have similar geometric patterns. In the exemplifying case illustrated in FIG. 5a, each of the surfaces 511-515 has a diagonal geometric pattern constituted by first areas depicted in FIG. 5a with vertical hatching and by second areas depicted in FIG. 5a with horizontal hatching. The surfaces 511-515 are differentiated from each other so that the second areas of different ones of the surfaces 511-515 have different interacting properties with the radiation used in the radiation-based imaging. In FIG. 5a, the differences in the interacting properties are depicted with the spacing of the horizontal hatching.

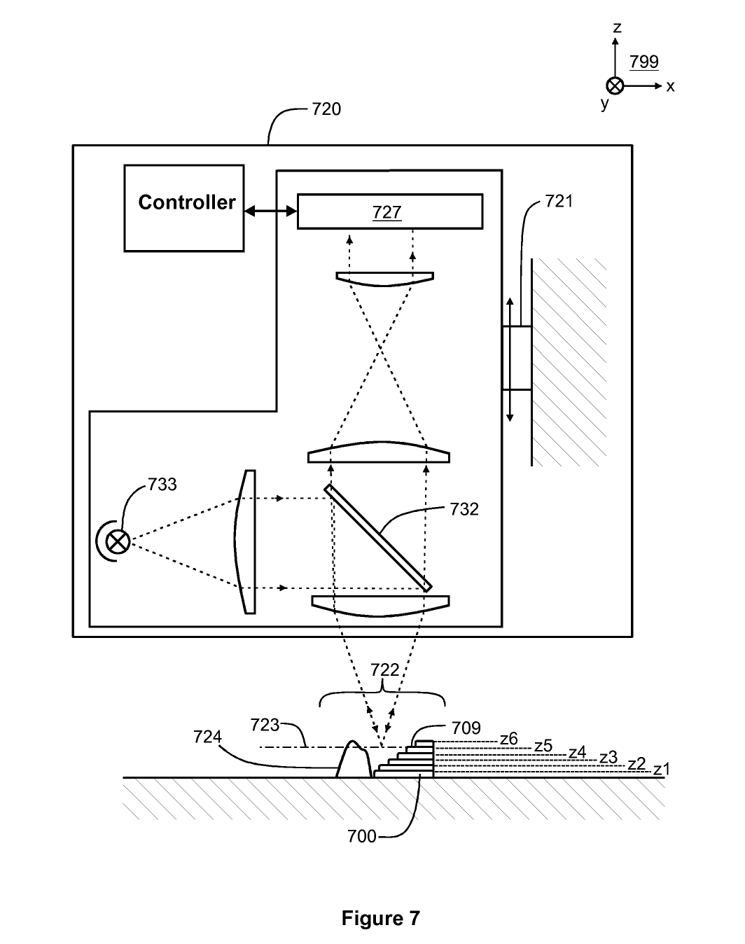

FIG. 6 shows a flowchart of a method according to an exemplifying and non-limiting embodiment of the invention for improving the vertical resolution of radiation-based imaging of a sample. The method comprises the following actions:
action 601: placing the sample and an artifact according to an embodiment of the invention to be concurrently in the field-of-view “FOV” during the radiation-based imaging, adjacent steps of the stepped thickness profile of the artifact interacting differently with the radiation used in the radiation-based imaging,
action 602: producing a radiation-based imaging result when one of the steps of the artifact is, in the vertical direction, closer to the imaging plane related to the radiation-based imaging than any other step of the artifact, and
action 603: associating, with the radiation-based imaging result, a pre-determined vertical position-value related to the one of the steps of the artifact.

The above-mentioned artifact can be, for example but not necessarily, similar to the artifact 100 illustrated in FIGS. 1a and 1b, or to the artifact 200 illustrated in FIG. 2, or to the artifact 300 illustrated in FIG. 3, or to the artifact 400 illustrated in FIGS. 4a and 4b, or to the artifact 500 illustrated in FIGS. 5a and 5b.

A method according to an exemplifying and non-limiting embodiment of the invention comprises, prior to the producing the imaging result, adjusting a vertical position of the imaging plane so that the one of the steps of the artifact is closer to the imaging plane in the vertical direction than any other step of the artifact.

In a method according to an exemplifying and non-limiting embodiment of the invention, the radiation-based imaging is microscopy and the imaging plane is a focal plane of a microscope used for the radiation-based imaging.

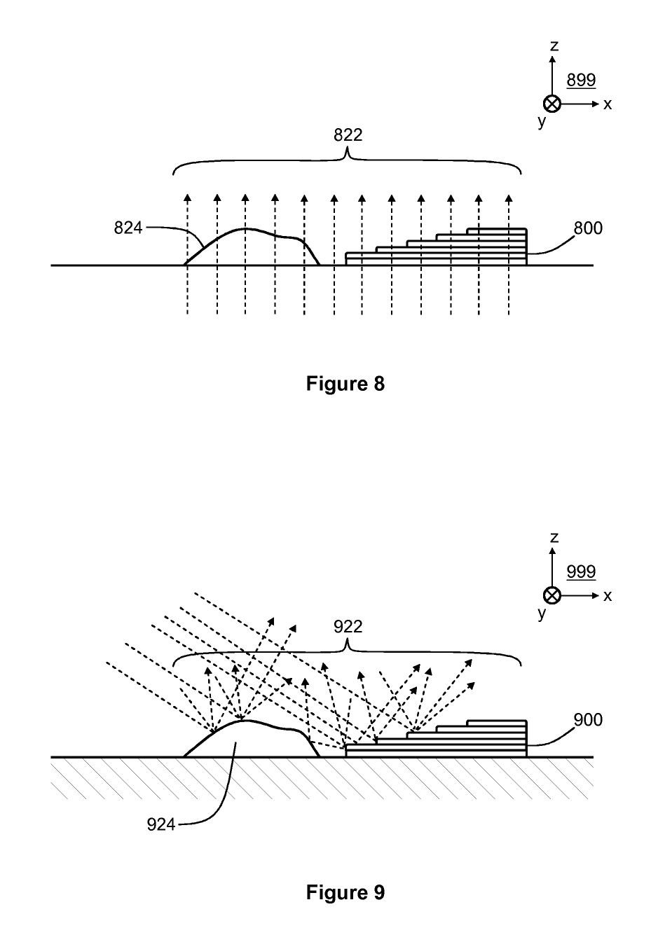

FIG. 7 shows a schematic illustration of a system according to an exemplifying and non-limiting embodiment of the invention for radiation-based imaging of a sample 724. The system comprises an artifact 700 that can be, for example but not necessarily, similar to the artifact 100 illustrated in FIGS. 1a and 1b, or to the artifact 300 illustrated in FIG. 3, or to the artifact 400 illustrated in FIGS. 4a and 4b, or to the artifact 500 illustrated in FIGS. 5a and 5b. The artifact 700 has a stepped thickness profile where adjacent steps are arranged to interact differently with the electromagnetic radiation used in the radiation-based imaging. In the exemplifying case shown in FIG. 7, the artifact 700 has six steps at vertical positions indicated by vertical position-values z1, z2, z3, z4, z5, and z6. The vertical positions can be defined as vertical distances from a suitable reference level. In the exemplifying case shown in FIG. 7, the vertical distances are measured along the z-direction of a coordinate system 799.

The system comprises an imaging device 720 for producing an imaging result based on first waves arriving from the sample 724 and second waves arriving from the artifact 700 when the sample and the artifact are concurrently in the field-of-view “FOV” 722 of the imaging device 720. In the exemplifying system illustrated in FIG. 7, the imaging device 720 comprises a radiation source 733 and a dichroic mirror 732 for directing the radiation to the sample 724 and to the artifact 700. The imaging device 720 comprises an imaging sensor 727 that can be e.g. a charge-coupled device “CCD” sensor. Furthermore, the imaging device 720 comprises lenses for focusing and collimating the radiation in desired ways. The imaging device 720 comprises a translation mechanism 721 for vertically translating the imaging plane 723 related to the radiation-based imaging. In the exemplifying situation shown in FIG. 7, the vertical position of the imaging plane 723 is such that the imaging plane 723 substantially coincides with the step 709 of the artifact 700. Therefore, an imaging result obtained in the exemplifying situation shown in FIG. 7 can be associated with the vertical position-value z5.

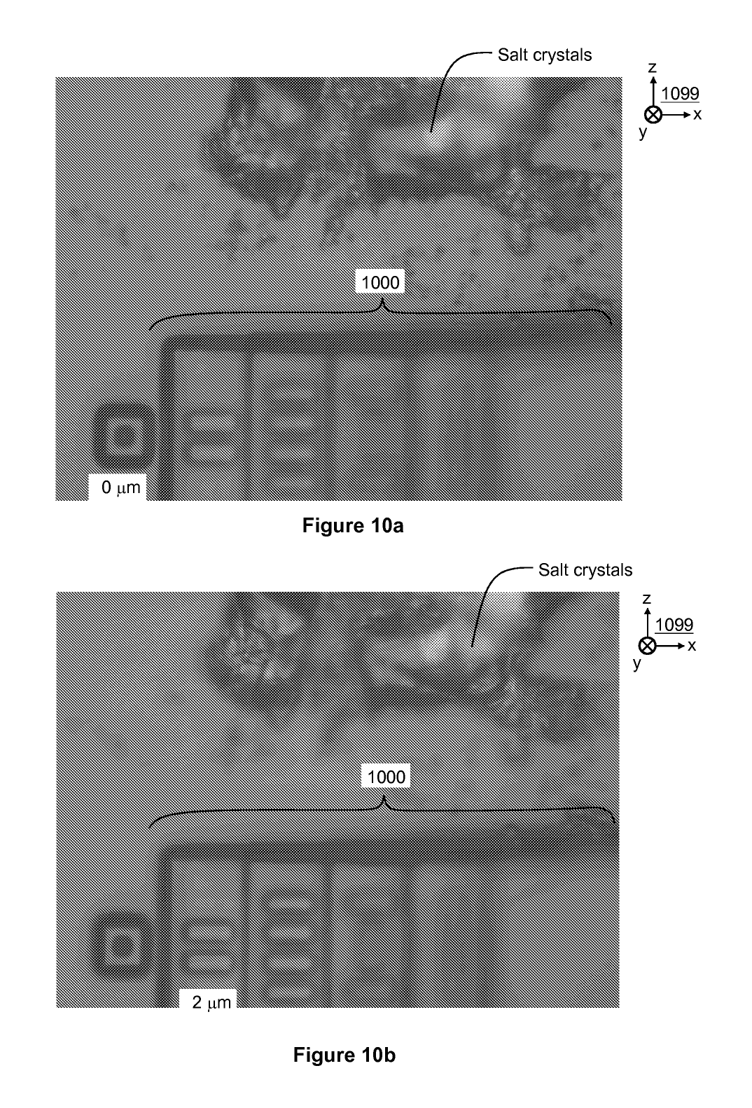

FIG. 8 illustrates a part of a system according to an exemplifying and non-limiting embodiment of the invention for radiation-based imaging of a sample 824. The system comprises an artifact 800 that is located together with the sample 824 in the field-of-view “FOV” 822 related to the radiation-based imaging. In this exemplifying case, the radiation penetrates the sample 824 and the artifact 800 in the positive z-direction of a coordinate system 899. The artifact 800 that can be, for example but not necessarily, similar to the artifact 200 illustrated in FIG. 2.

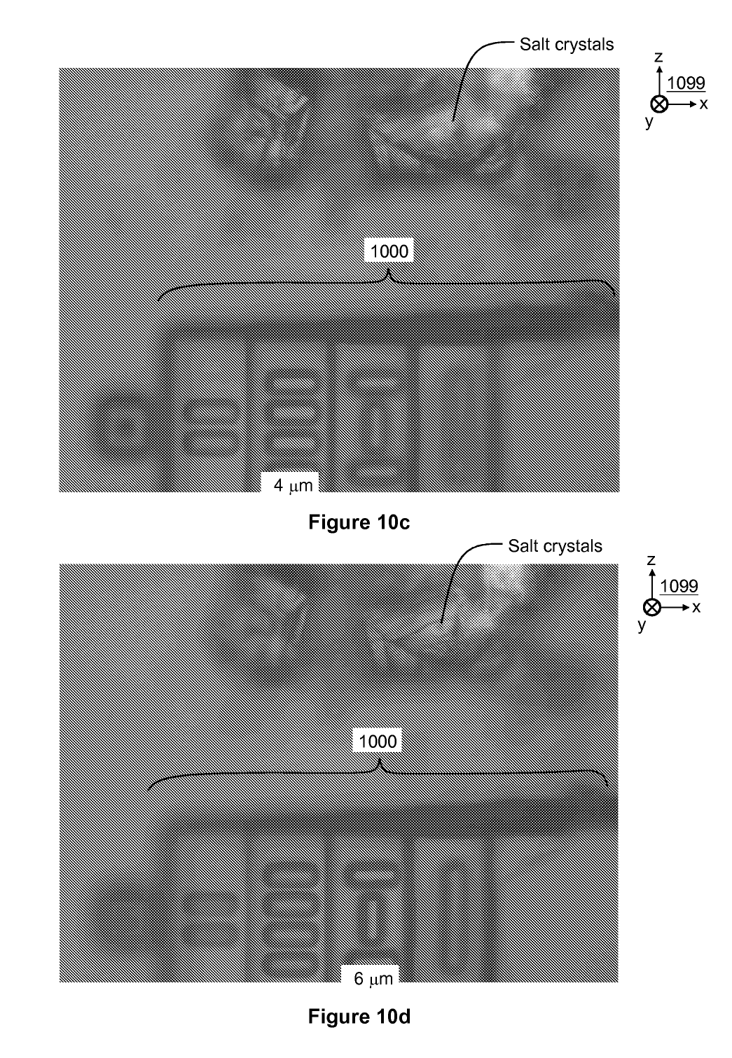

FIG. 9 illustrates a part of a system according to an exemplifying and non-limiting embodiment of the invention for radiation-based imaging of a sample 924. The system comprises an artifact 900 that is located together with the sample 924 in the field-of-view “FOV” 922 related to the radiation-based imaging. In this exemplifying case, the radiation arrives obliquely from above and the radiation is scattered and reflected from the sample 924 and from the artifact 900. The artifact 900 that can be, for example but not necessarily, similar to the artifact 100 illustrated in FIGS. 1a and 1b, or to the artifact 300 illustrated in FIG. 3, or to the artifact 400 illustrated in FIGS. 4a and 4b, or to the artifact 500 illustrated in FIGS. 5a and 5b.

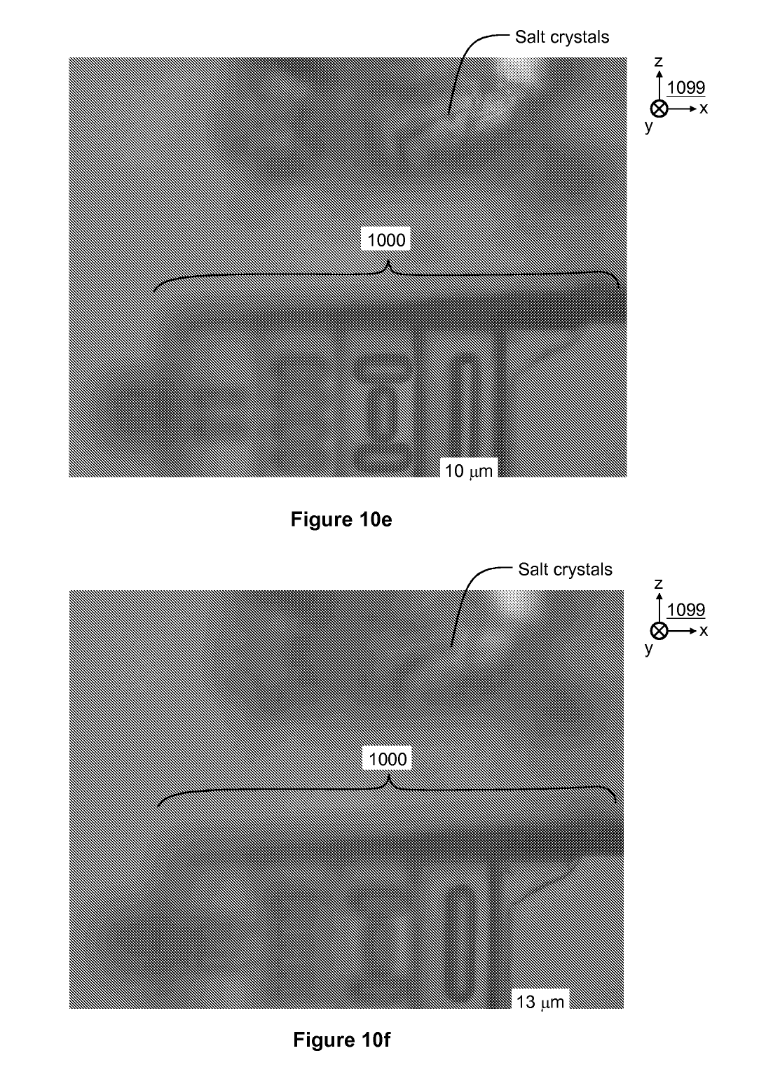

FIGS. 10a-10f illustrate a usage of an artifact 1000 according to an exemplifying and non-limiting embodiment of the invention. In the exemplifying situation, the artifact 1000 and salt crystals are in the same field-of-view “FOV” of optical microscopy. The artifact 1000 has five steps so that, in the z-direction of a coordinate system 1099, the first step is 2 μm above a base level marked with 0 μm in FIG. 10a, the second step is 4 μm above the base level, the third step is 6 μm above the base level, the fourth step is 10 μm above the base level, and the fifth step is 13 μm above the base level. FIG. 10a shows a situation where the focal plane of the optical microscopy coincides with the base level, FIG. 10b shows a situation where the focal plane coincides with the 2 μm first step, FIG. 10c shows a situation where the focal plane coincides with the 4 μm second step, FIG. 10d shows a situation where the focal plane coincides with the 6 μm third step, FIG. 10e shows a situation where the focal plane coincides with the 10 μm fourth step, and FIG. 10f shows a situation where the focal plane coincides with the 13 μm fifth step.

The non-limiting, specific examples provided in the description given above should not be construed as limiting the scope and/or the applicability of the appended claims. Furthermore, any list or group of examples presented in this document is not exhaustive unless otherwise explicitly stated.

1-19. (canceled)

20. An artifact for improving vertical resolution of radiation-based imaging, the artifact having a stepped thickness profile with steps, wherein adjacent ones of the steps are arranged to interact differently with radiation used in the radiation-based imaging so that each step is arranged to interact differently with the radiation than any step adjacent to the first-mentioned step.

21. An artifact according to claim 20, wherein surfaces of the adjacent ones of the steps have different reflective properties.

22. An artifact according to claim 20, wherein the adjacent ones of the steps have different radiation-transmission properties.

23. An artifact according to claim 20, wherein surfaces of the adjacent ones of the steps have different scattering properties.

24. An artifact according to claim 20, wherein the artifact comprises substances having wavelength-dependent interacting properties with the radiation used in the radiation-based imaging so that the interacting properties of the adjacent ones of the steps have different wavelength dependencies.

25. An artifact according to claim 20, wherein surfaces of the steps have geometric patterns of areas having different interacting properties with the radiation used in the radiation-based imaging so that the adjacent ones of the steps have different geometric patterns.

26. An artifact according to claim 20, wherein surfaces of the steps have geometric patterns of areas having different interacting properties with the radiation used in the radiation-based imaging so that the adjacent ones of the steps have similar geometric patterns so that the interacting properties of at least one of the areas of a first one of the similar geometric patterns differs from the interacting properties of a corresponding one of the areas of a second one of the similar geometric patterns.

27. An artifact according to claim 20, wherein surfaces of the steps have textures having different interacting properties with the radiation used in the radiation-based imaging so that adjacent ones of the steps have different textures.

28. An artifact according to claim 20, wherein the artifact comprises particles interacting with the radiation used in the radiation-based imaging so that the adjacent ones of the steps have different interacting properties with the radiation used in the radiation-based imaging.

29. An artifact according to claim 28, wherein the particles of the adjacent ones of the steps are different from each other.

30. An artifact according to claim 28, wherein the particles of the adjacent ones of the steps are arranged to constitute different geometric patterns.

31. An artifact according to claim 20, wherein the artifact comprises a substrate and material constituting the stepped thickness profile is on top of the substrate.

32. An artifact according to claim 31, wherein the substrate is made of highly ordered pyrolytic graphite substrate.

33. An artifact according to claim 20, wherein the artifact comprises layers having pre-determined thicknesses and being stacked on top of each other in a vertical direction and in a partially overlapping way so as to form the stepped thickness profile.

34. An artifact according to claim 33, wherein at least one of the layers comprises a polymer film.

35. An artifact according to claim 33, wherein at least one of the layers comprises a Langmuir-Blodgett film.

36. A method for improving vertical resolution of radiation-based imaging of a sample, the method comprising:
placing the sample and an artifact to be concurrently in a field-of-view during the radiation-based imaging, the artifact having a stepped thickness profile with steps, and adjacent ones of the steps being arranged to interact differently with radiation used in the radiation-based imaging so that each step is arranged to interact differently with the radiation than any step adjacent to the first-mentioned step,
producing a radiation-based imaging result when one of the steps of the stepped thickness profile of the artifact is, in a vertical direction, closer to an imaging plane related to the radiation-based imaging than any other one of the steps, and
associating, with the radiation-based imaging result, a pre-determined vertical position-value related to the one of the steps.

37. A method according to claim 36, wherein the radiation-based imaging is microscopy and the imaging plane is a focal plane of a microscope used for the radiation-based imaging.

38. A system for radiation-based imaging of a sample, the system comprising:
an artifact having a stepped thickness profile with steps, adjacent ones of the step being arranged to interact differently with radiation used in the radiation-based imaging so that each step is arranged to interact differently with the radiation than any step adjacent to the first-mentioned step, and
an imaging device for producing an imaging result based on first waves arriving from the sample and second waves arriving from the artifact when the sample and the artifact are concurrently in a field-of-view of the imaging device,
wherein the imaging device comprises a translation mechanism for vertically translating an imaging plane related to the radiation-based imaging.
